(19) United States
(12) Patent Application Publication
(10) Pub. No.: US 2002/0086635 A1
(43) Pub. Date: Jul. 4, 2002

(54) Portable radio telephone with power controller and method of controlling the same

(75) Inventor: Takahiko Tomono, Kanagawa (JP)

Correspondence Address: McGinn & Gibb, PLLC, Suite 200, 8321 Old Courthouse Road, Vienna, VA, 22182-3817, US

(73) Assignee: NEC Corporation

(21) Appl. No.: 10/005,340

(22) Filed: Dec. 7, 2001

(30) Foreign Application Priority Data
Dec. 8, 2000 (JP) 374580/2000

(51) Int. Cl. H04M 3/42

(52) U.S. Cl. 455/1; 455/456; 455/414

(57) ABSTRACT

A portable radio telephone is provided, which turns off or on automatically the communication function when the user enters a prohibited area or exits from the area, respectively, and at the same time, the built-in additional convenient functions are kept operable even after the communication function is turned off. The telephone comprises: (a) a radio section for receiving an input radio signal and/or transmitting an output radio signal; (b) a power supply controller for controlling supply of electric power to the radio section responsive to reception of a power-off signal; the power-off signal being transmitted from a power-off signal transmitter provided in a prohibited area where use of a portable radio telephone is prohibited; and (c) a power-off signal sensor for sensing reception of the power-off signal to notify the power supply controller of reception of the power-off signal. When the power-off signal sensor senses reception of the power-off signal, the power supply controller stops supply of electric power to the radio section while keeping additional built-in functions other than communication function operable. When the power-off signal sensor does not sense reception of the power-off signal, the power supply controller continues supply of electric power to the radio section.

### BACKGROUND OF THE INVENTION

1. Field of the Invention

The present invention relates to a portable radio telephone with a power controller for controlling the supply of electric power to the radio section. More particularly, the invention relates to a portable radio telephone the operation of which is halted if the telephone enters a specific area where the use of radio telephones is prohibited due to bad effects induced by radio or electromagnetic wave, sound, or voice emitted from the telephone.

2. Description of the Related Art

Conventionally, the use of portable radio telephones is prohibited in specific areas (which are termed simply “prohibited areas” in this specification) such as hospitals, airplanes, and vehicles. This is because the radio wave or electromagnetic wave emitted from the telephones applies serious bad effects to precision instruments, such as medical or flight instruments or apparatuses provided in the areas. Alternately, this is because the user's voice or sound from the telephone annoys or disturbs the patients or passengers around the user.

Usually, the user has to turn off the power of his/her own radio telephone manually when he or she enters the prohibited area and then, he or she has to turn on the power again when exits from there. This behavior is troublesome for the user. At the same time as this, the built-in additional convenient functions (e.g., clock, telephone directory, and scheduler functions) of the telephone other than the communication function of speech and/or data are all inoperable after the power is turned off. This state is very inconvenient for the user.

Moreover, if the user forgets to turn off the power of his/her telephone when he or she enters the prohibited area, there arises a danger that the medical or flight instruments are applied with serious effects by the telephone.

Therefore, there is the need to automatically turn off the telephone if the user enters the prohibited area and to automatically turn on again the same if the user exits from the area. To fulfill this need, various techniques have been developed and disclosed so far.

For example, the Japanese Patent No. 2965007 issued on Oct. 18, 1999 discloses a portable telephone system. This system comprises a private or simplified base station mounted at the boundary of a prohibited area where the use of portable telephones is prohibited. The station emits an indication signal that turns on or off the power supply of portable radio telephones by radio. When a portable radio telephone enters the prohibited area, the telephone receives the indication signal from the private base station. At this time, the telephone sends a specific signal for halting the communication with this telephone to the private base station and then, the telephone turns off its power supply. The private base station sends a specific signal for halting the communication with the telephone that sends the specific signal to a public base station within a radio network at which the position of the telephone is registered. Thus, communication from and to the telephone is prevented automatically, in other words, the turn-on and turn-off operation of the telephone is automatically performed.

With the portable telephone system disclosed by the Patent No. 2965007, the turn-on and turn-off operations of the telephone are automatically performed. However, the problem that the built-in additional convenient functions of the telephone are inoperable after the power is turned off remains unsolved.

The Japanese Non-Examined Patent Publication No 11-308163 published on Nov. 5, 1999 discloses a portable telephone terminal. This terminal comprises a communication stop key, a stop recognition section, a CPU (Central Processing Unit), and a controller section. If the user presses the communication stop key, the stop recognition section recognizes the user's instruction to stop communication and then, sends a communication stop request to the controller section. Responsive to the communication stop request, the controller section sends a specific flag or interruption signal to the CPU. In response to the flag or interruption signal, the CPU outputs a power-supply stop signal to the controller section. In response to the power-supply stop signal, the controller section stops the supply of electric power to the radio section and the baseband signal processing section, thereby stopping the communication function of the telephone terminal.

With the portable telephone terminal disclosed by the Publication No. 11-308163, if the user presses the communication stop key, in other words, if the user manually instructs the terminal to stop its communication functions, the communication is prevented while keeping the built-in additional convenient functions of the telephone operable. However, the turn-on and turn-off operations of the telephone terminal are not automatically performed according to entrance to the prohibited area and exit therefrom.

### SUMMARY OF THE INVENTION

Accordingly, an object of the present invention is to provide a portable radio telephone and a control method thereof that turn off or on automatically the communication function when the user enters a prohibited area or exits from the area, respectively, and at the same time, the built-in additional convenient functions are kept operable even after the communication function is turned off.

Another object of the present invention is to provide a portable radio telephone and a control method thereof that prevent surely the effect to precision instruments located in the prohibited area even if the user turns on intentionally or mistakenly the power supply of the telephone in the prohibited area.

The above object together with others not specifically mentioned will become clear to those skilled in the art from the following description.

According to a first aspect of the invention, a portable radio telephone is provided, which comprises:

(a) a radio section for receiving an input radio signal and/or transmitting an output radio signal;

(b) a power supply controller for controlling supply of electric power to the radio section responsive to reception of a power-off signal;

the power-off signal being transmitted from a power-off signal transmitter provided in a prohibited area where use of a portable radio telephone is prohibited; and

(c) a power-off signal sensor for sensing reception of the power-off signal to notify the power supply controller of reception of the power-off signal;

wherein when the power-off signal sensor senses reception of the power-off signal, the power supply controller stops supply of electric power to the radio section while keeping additional built-in functions other than communication function operable;

and wherein when the power-off signal sensor does not sense reception of the power-off signal, the power supply controller continues supply of electric power to the radio section.

With the portable radio telephone according to the first aspect of the invention, since the power-off signal is transmitted from the power-off signal transmitter provided in the prohibited area, the power-off signal sensor senses the reception of the power-off signal if the user carries the telephone into the prohibited area. When the sensor senses the reception of the power-off signal, the sensor notifies the power supply controller of the reception of the power-off signal. In response to the notification of the reception of the power-off signal from the sensor, the power supply controller stops the supply of electric power to the radio section while keeping additional built-in functions other than the communication function operable. Thus, in this state, the communication function is turned off while the additional functions are operable.

Moreover, if the user carries the telephone out of the prohibited area, the sensor does not sense the reception of the power-off signal. In this states the power supply controller continues supply of electric power to the radio section. This means that the telephone is communicable and the additional functions are operable in this state.

As a result, when the user enters the prohibited area or exits therefrom, the communication function of the telephone is automatically turned off or on, respectively.

Moreover, the operations of turning-on and turning-off the communication function of the telephone are automatically performed by turning-on and turning-off the supply of electric power to the radio section, not by turning-on and turning-off the telephone itself. Therefore, the built-in additional functions of the telephone are kept operable even after the power supply is turned off.

In a preferred embodiment of the telephone according to the first aspect of the invention, a connection controller is additionally provided. The connection controller sends a stop signal to a relating base station to the telephone to stop a connection operation of the base station to the telephone when the power supply controller stops the supply of electric power to the radio section. The connection controller sends a stop release signal to the relating base station to the telephone to restart the connection operation of the base station to the telephone when the power supply controller restarts the supply of electric power to the radio section. In this embodiment, there is an additional advantage that the effect to precision instruments located in the prohibited area is surely prevented even if the user turns on intentionally or mistakenly the power supply of the telephone in the prohibited area.

In another preferred embodiment of the telephone according to the first aspect of the invention, the power-off signal sensor senses the reception of the power-off signal independent of whether the radio section operates or not.

In still another preferred embodiment of the telephone according to the first aspect of the invention, a non-volatile storage for storing a power-off signal reception code is additionally provided. When the power-off signal sensor senses reception of the power-off signal, the power-off signal reception code is stored in the storage and kept unchanged even after the telephone is turned off. When the telephone is turned on, it is judged whether the power-off signal reception code is stored in the storage or not. If the power-off signal reception code is stored in the storage, the power supply controller keeps the supply of electric power to the radio section stopped. If the power-off signal reception code is not stored in the storage, the power supply controller restarts the supply of electric power to the radio section.

In a further preferred embodiment of the telephone according to the first aspect of the invention, when the power-off signal sensor does not sense reception of the power-off release signal, the power-off signal reception code stored in the storage is deleted.

In a still further preferred embodiment of the telephone according to the first aspect of the invention, a power-off release signal sensor for sensing reception of a power-off release signal to notify the power supply controller of reception of the power-off release signal is additionally provided. The power-off release signal is transmitted from a power-off release signal transmitter in such a way that the power-off release signal sensor senses the power-off release signal when the telephone is carried out of the prohibited area.

According to a second aspect of the invention, a method of controlling a portable radio telephone is provided, which comprises the steps of:

(a) providing a power-off signal transmitter for transmitting a power-off signal in a prohibited area where use of a portable radio telephone is prohibited;

(b) providing a power-off signal sensor for sensing reception of the power-off signal on a portable radio telephone;

the telephone having a radio section for receiving an input radio signal and/or transmitting an output radio signal;

(c) judging whether the power-off signal sensor senses reception of the power-off signal or not; and

(d) stopping supply of electric power to the radio section of the telephone while keeping additional built-in functions of the telephone other than communication function operable if the power-off signal sensor senses reception of the power-off signal in the step (c);

the supply of electric power to the radio section of the telephone being continued if reception of the power-off signal is not sensed in the step (c).

With the method of controlling a portable radio telephone according to the second aspect of the invention, because of substantially the same reason as the telephone according to the first aspect of the invention, there are the same advantages as those of the telephone.

In a preferred embodiment of the method according to the second aspect of the invention, a step of providing a connection controller on the telephone is additionally carried out. The connection controller sends a stop signal to a relating base station to the telephone to stop a connection operation of the base station to the telephone when the power supply controller stops the supply of electric power to the radio section. The connection controller sends a stop release signal to the relating base station to the telephone to restart the connection operation of the base station to the telephone when the power supply controller restarts the supply of electric power to the radio section. In this embodiment, there is an additional advantage that the effect to precision instruments located in the prohibited area is surely prevented even if the user turns on intentionally or mistakenly the power supply of the telephone in the prohibited area.

In another preferred embodiment of the method according to the second aspect of the invention, the reception of the power-off signal is carried out by the power-off signal sensor independent of whether the radio section operates or not.

In still another preferred embodiment of the method according to the second aspect of the invention, a step of providing a non-volatile storage for storing a power-off signal reception code on the telephone is additionally carried out. When the power-off signal sensor senses reception of the power-off signal, the power-off signal reception code is stored in the storage and kept unchanged even after the telephone is turned off. When the telephone is turned on, it is judged whether the power-off signal reception code is stored in the storage or not. If the power-off signal reception code is stored in the storage, the power supply controller keeps the supply of electric power to the radio section stopped. If the power-off signal reception code is not stored in the storage, the power supply controller restarts the supply of electric power to the radio section.

In a further preferred embodiment of the method according to the second aspect of the invention, when the power-off signal sensor does not sense reception of the power-off release signal, the power-off signal reception code stored in the storage is deleted.

In a still further preferred embodiment of the method according to the second aspect of the invention, a step of providing a power-off release signal sensor for sensing reception of a power-off release signal to notify the power supply controller of reception of the power-off release signal on the telephone is additionally carried out. The power-off release signal is transmitted from a power-off release signal transmitter in such a way that the power-off release signal sensor senses the power-off release signal when the telephone is carried out of the prohibited area.

### BRIEF DESCRIPTION OF THE DRAWINGS

In order that the present invention may be readily carried into effect, it will now be described with reference to the accompanying drawings.

FIG. 1 is a schematic functional block diagram showing the configuration of a portable radio telephone according to a first embodiment of the invention.

FIG. 2 is a schematic view showing the relationship among the portable radio telephone according to the first embodiment of FIG. 1, a power-off signal transmitter, and a relating base station to the telephone.

FIGS. 3A and 3B are a flowchart diagram showing the operation of the portable radio telephone according to the first embodiment of FIG. 1.

FIG. 4 is a schematic functional block diagram showing the configuration of a portable radio telephone according to a second embodiment of the invention.

FIG. 5 is a schematic view showing the relationship among the portable radio telephone according to the second embodiment of FIG. 4, a power-off signal transmitter, a power-off release signal transmitter, and a relating base station to the telephone.

FIGS. 6A and 6B are a flowchart diagram showing the operation of the portable radio telephone according to the second embodiment of FIG. 4.

### DETAILED DESCRIPTION OF THE PREFERRED EMBODIMENTS

Preferred embodiments of the present invention will be described in detail below while referring to the drawings attached.

### First Embodiment

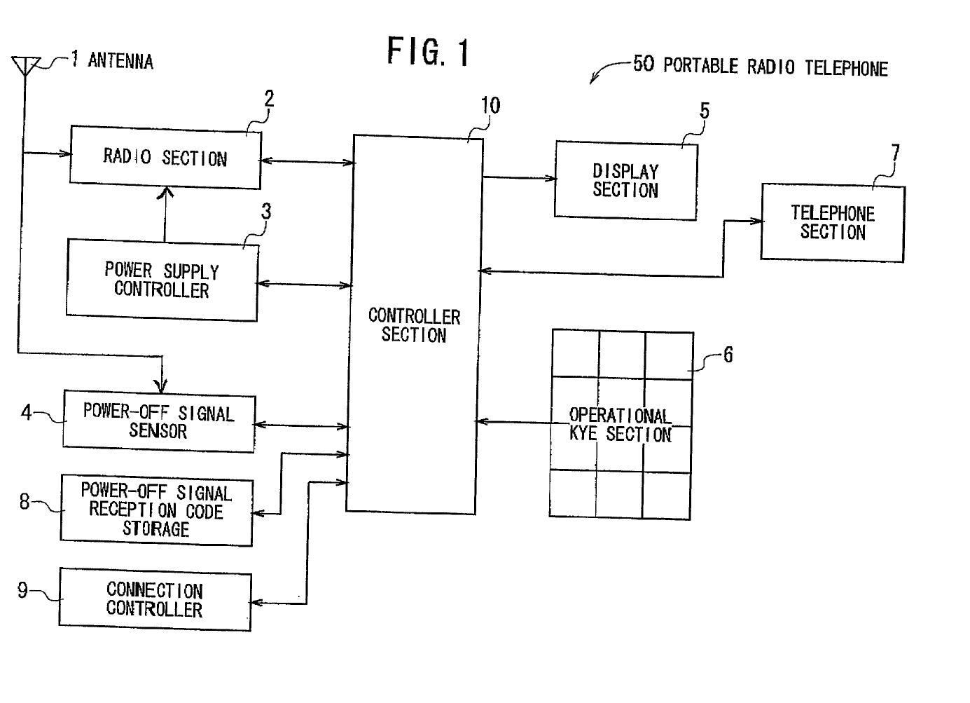

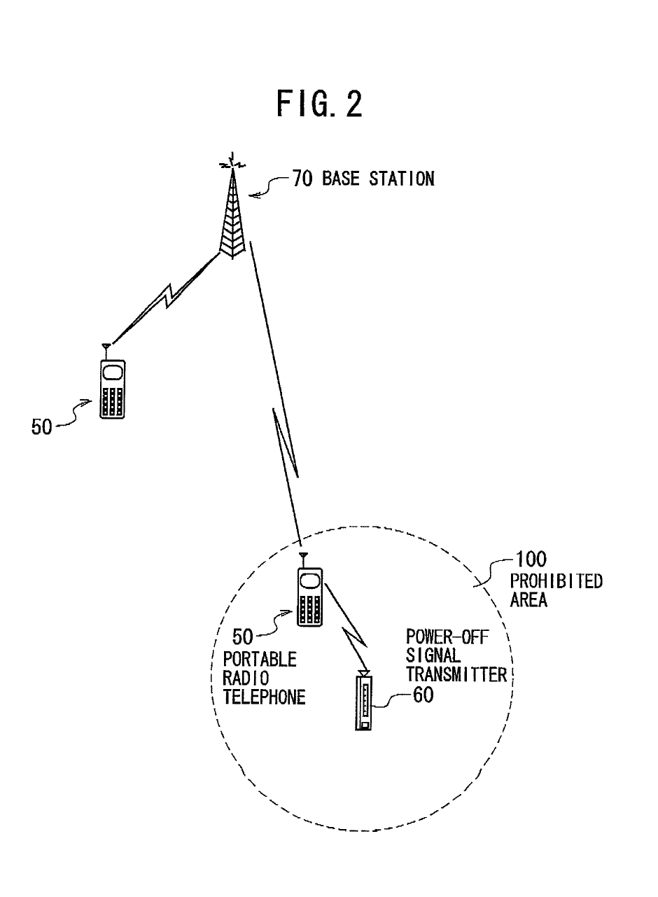

A portable radio telephone 50 according to a first embodiment of the invention has the configuration shown in FIG. 1. The telephone 50 is used in the circumstances shown in FIG. 2.

Specifically, a radio section 2 receives an input voice or data signal and an input control signal that have been transmitted from the outside of the telephone 50 in the form of radio wave by way of an antenna 1. On the other hand, the section 2 transmits an output voice or data signal and an output control signal that have been generated in the telephone 50 by way of the antenna 1 in the form of radio wave.

A power supply controller 3 controls the supply of electronic power to the radio section 2. In other words, the controller 3 turns on the supply of electric power to the radio section 2 to activate the same, or turns off the supply of electric power to the section 2 to inactivate the same. This turn-on and turn-off operations are carried out responsive to the reception of a specific power-off signal. The power-off signal is transmitted from a power-off signal transmitter 60 provided in a prohibited area 100 where the use of portable radio telephones 50 is prohibited.

A power-off signal sensor 4 senses the reception of the power-off signal transmitted from the transmitter 60. The sensor 4 conducts its sensing operation independent of whether the radio section 2 is operable or not. Therefore, the sensor 4 can sense the power-off signal even if the radio section 2 is kept inoperable due to the stop of supply of electric power.

A display section 5, which includes a Liquid-Crystal Display (LCD) unit (not shown in FIG. 1) with a screen, displays various types of necessary information on the screen. For example, the section 5 displays on its screen the fact that the power-off signal has been received and therefore, the communication function of the telephone 50 is in the inoperable state.

An operational key section 6 includes a set of keys for instructing start of the transmission and/or reception operation and for choosing or setting a desired one of the built-in additional convenient functions (e.g., clock, telephone directory, and scheduler functions).

A telephone section 7 conducts the specific telephone functions, i.e., exchange of speeches or voice messages and transmission/reception of data.

A power-off signal reception code storage 8 provides a non-volatile memory function that stores a power-off signal reception code if the power-off signal sensor 4 senses the reception of the power-off signal. Moreover, the storage 8 deletes the power-off signal reception code if the power-off signal sensor 4 does not sense the reception of the power-off signal, in other words, if the reception of the power-off signal disappears.

A connection controller 9 controls the connection of the telephone 50 to a relating base station 70 or disconnection of the telephone 50 from the base station 70 by radio.

A controller section 10 controls the entire operation of the telephone 50.

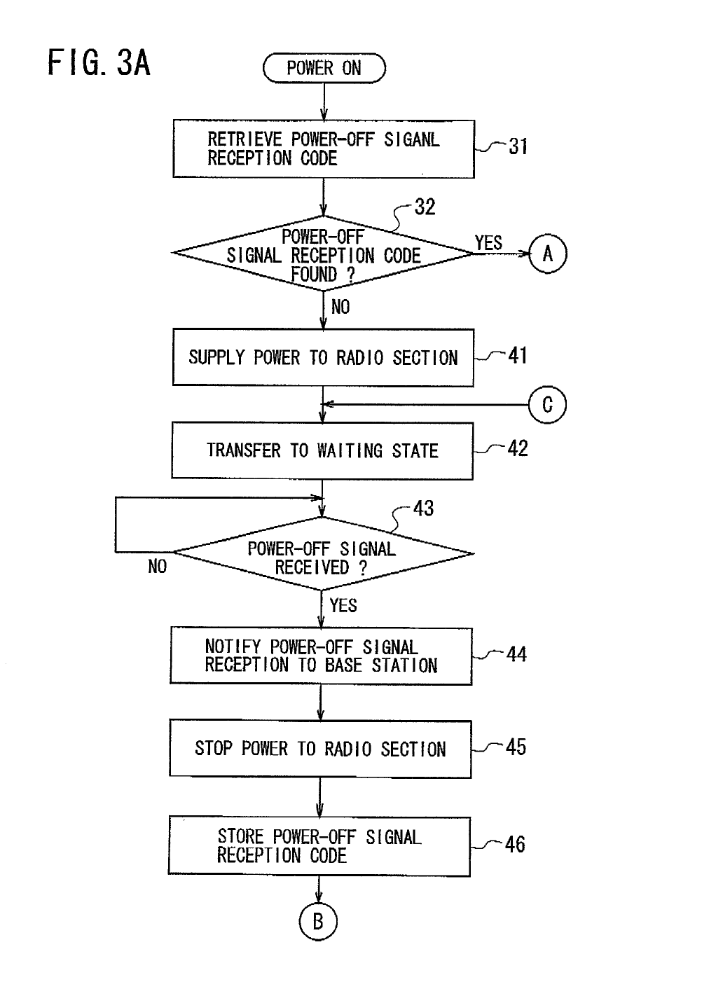

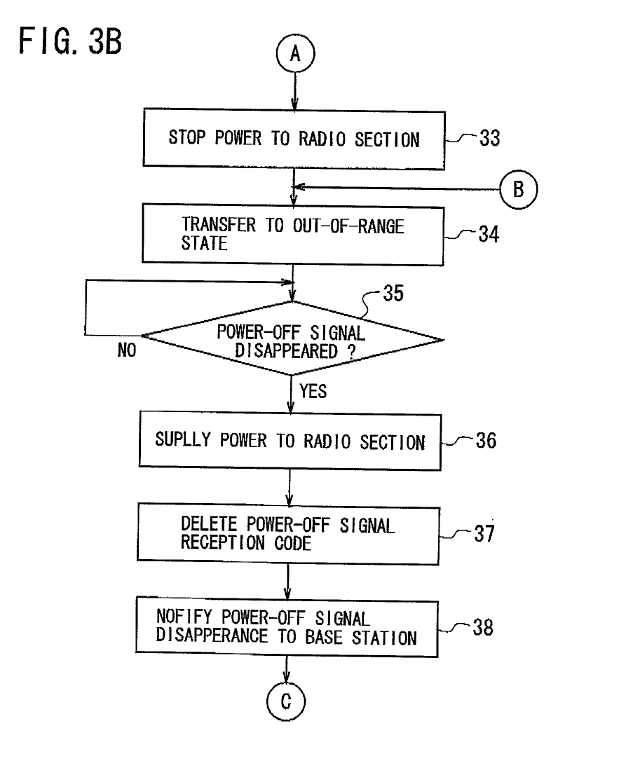

Next, the operation of the telephone 50 of the first embodiment of the invention is explained in detail below with reference to FIGS. 3A and 3B. FIGS. 3A and 3B show the operation after the power switch of the telephone 50 is turn on.

In the step 31, immediately after the power of the telephone 50 is turned on by the user, the controller 10 retrieves the power-off signal reception code from the power-off signal reception code storage 8.

When the user carries the telephone 50 into the prohibited area 100, the power-off signal sensor 4 senses the reception of the power-off signal transmitted from the power-off signal transmitter 60 mounted in the area 100. At this time, the controller section 10 stores the power-off signal reception code in the power-off signal reception code storage 8. Since the storage 8 has a non-volatile memory function, the power-off signal reception code thus stored in the storage 8 is kept unchanged even after the power of the telephone 50 itself is turned off.

Then, in the step 32, the controller 10 checks whether the power-off signal reception code is found in the storage 8 or not. If the power-off signal reception code is found in the storage 8, in other words, if the telephone 50 has received the power-off signal from the power-off signal transmitter 60, the judgment in the step 32 is “YES”. Therefore, the operational flow is jumped to the step 33, in which the power supply controller 3 stops supplying electric power to the radio section 2 of the telephone 50. Thus, the telephone 50 is transferred to the “out-of-range state” in the step 34. In this state, only the supply of electric power to the radio section 2 is stopped and therefore, only the communication function is made inoperable while the built-in additional functions, such as the clock and telephone directory functions, are kept alive or available.

In the step 35, the controller 10 checks whether the power-off signal has disappeared or not by way of the sensor 4. This check is continued until the answer is “YES”, i.e., the controller 10 recognizes the fact that the power-off signal has disappeared.

In the next step 36, the power supply controller 3 restarts supplying electric power to the radio section 2 of the telephone 50, because the power-off signal has disappeared by bringing the telephone 50 out of the prohibited area 100. Thereafter, the controller 10 deletes the power-off signal reception code from the storage 8 in the step 37, and notifies the power-off signal disappearance to the base station 70 in the step 38.

Subsequent to the step 38, the flow is jumped to the step 42, in which the telephone 50 is transferred to the “waiting state” for waiting signal/data transmission or reception. In this state, the communication function of the telephone 50 is active and at the same time, the built-in additional functions are kept available.

Here, the flow is returned to the step 32. If the result of judgment in the step 32 is “NO”, the power-off signal reception code is not stored in the storage 8. Thus, the flow is jumped to the step 41, in which the power supply controller 3 starts supplying electric power to the radio section 2 of the telephone 50. Thus, the telephone 50 is transferred to the “waiting state” in the step 42.

Following this, in the next step 43, the controller 10 checks whether the power-off signal has received or not by way of the sensor 4. This check is continued until the answer is “YES” in the step 43, i.e., the controller 10 recognizes the fact that the power-off signal has received. In this state, the power-off signal reception code is stored in the power-off signal reception code storage 8.

In the next step 44, the connection controller 9 notifies the fact that the telephone 50 has received the power-off signal and the telephone 50 should turn to the power-off state to the base station 70.

In the next step 45, the power supply controller 3 stops supplying electric power to the radio section 2. Then, in the step 46, the power-off signal reception code is stored in the storage 8. Thereafter, the flow is jumped to the step 34, in which the telephone 50 is transferred to the “out-of-range state”. The step 36 and its subsequent steps are carried out in due course.

With the portable radio telephone 50 according to the first embodiment of the invention, as described above, since the power-off signal is transmitted from the power-off signal transmitter 60 provided in the prohibited area 100, the power-off signal sensor 4 senses the reception of the power-off signal if the user carries the telephone 50 into the prohibited area 100. When the sensor 4 senses the reception of the power-off signal, the sensor 4 notifies the power supply controller 3 of the reception of the power-off signal. In response to the notification of the reception of the power-off signal from the sensor 4, the power supply controller 3 stops the supply of electric power to the radio section 2 while keeping additional built-in functions other than the communication function operable. Thus, in this state, the communication function of the telephone 50 is turned off while the additional built-in functions such as the clock function are kept operable.

Moreover, if the user carries the telephone 50 out of the prohibited area 100, the sensor 4 does not sense the reception of the power-off signal. In this state, the power supply controller 3 continues supply of electric power to the radio section 2. This means that the telephone 50 is communicable and the additional built-in functions are operable in this state.

As a result, when the user enters the prohibited area 100 or exits therefrom, the communication function of the telephone 50 is automatically turned off or on, respectively.

Moreover, the operations of turning-on and turning-off the communication function of the telephone 50 are automatically performed by turning-on and turning-off the supply of electric power to the radio section 2, not by turning-on and turning-off the power of the telephone 50 itself. Therefore, the built-in additional functions of the telephone 50 are kept operable even after the power supply is turned off.

Furthermore, when the power-off signal sensor 4 has sensed the power-off signal from the transmitter 60 and then, the power-off signal reception code storage 8 has stored the power-off signal reception code, the connection controller 9 notifies the fact that the telephone 50 has received the power-off signal and it should be power-off state to the base station 70. Therefore, the prevention of the bad effects by radio wave to the precision instruments, such as medical and flight instruments, in the area 100 is ensured.

In the telephone 50 according to the first embodiment, it is preferred that power supply to the radio section 2 may be manually stopped or started by a specific key operation made by the user. In this case, the specific key operation for this purpose is typically carried out with the operational key section 6.

More preferably, the power supply to the radio section 2 can be manually stopped or started by a specific key operation made by the user only when the telephone 50 has not received the power-off signal. When the telephone 50 has received the power-off signal, this manually stopping or starting operation is prevented.

### Second Embodiment

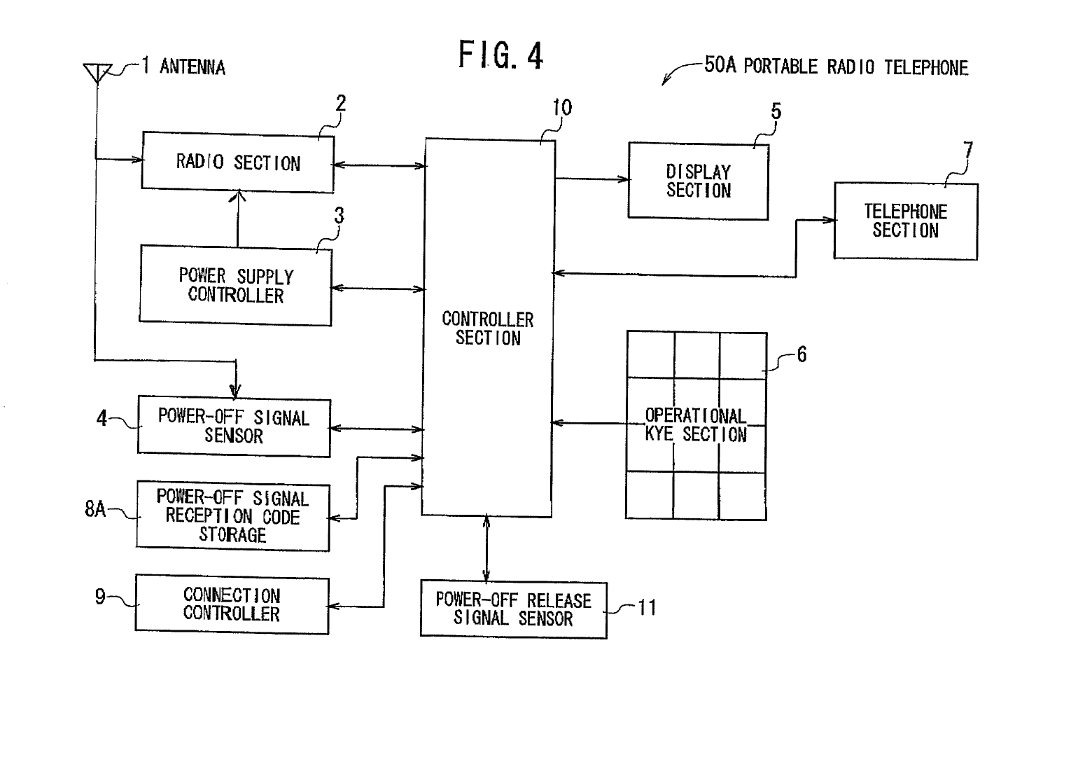

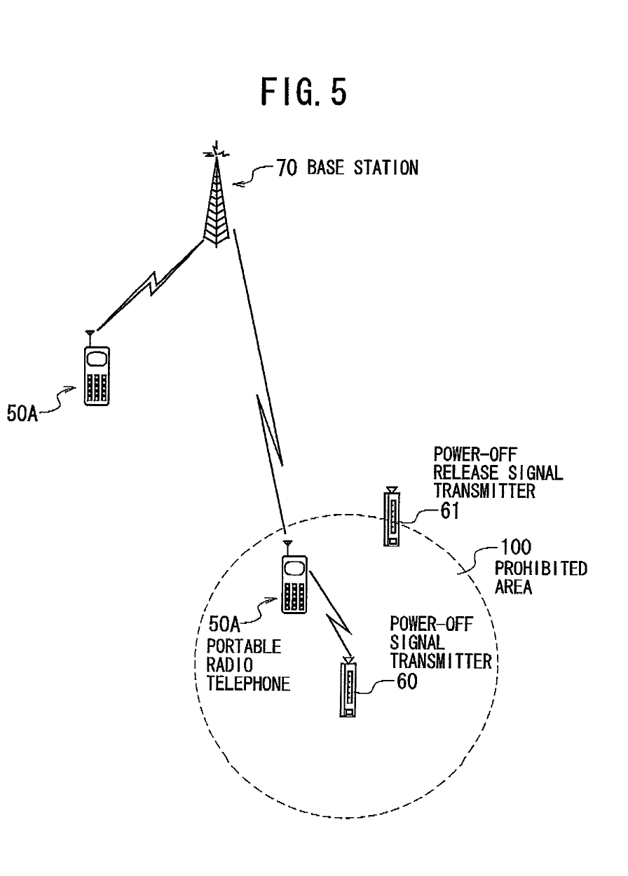

FIG. 4 shows the configuration of a portable radio telephone 50A according to a second embodiment of the invention. The telephone 50A is used in the circumstances shown in FIG. 5.

The configuration of the telephone 50A of the second embodiment is the same as that of the telephone 50 of the first embodiment of FIG. 1, except that a power-off release signal sensor 11 is additionally provided. Therefore, the explanation about the same configuration is omitted here for simplification by attaching the same reference symbols as those used in the first embodiment of FIG. 1.

The power-off release signal sensor 11 senses the reception of the power-off release signal. The power-off release signal is transmitted by a power-off release signal transmitter 61 mounted at the boundary or periphery of the prohibited area 100, as shown in FIG. 5. The transmitter 61 transmits the power-off release signal in such a way that the telephone 50A can receive the power-off release signal only near the boundary or periphery of the area 100.

A power-off signal reception code storage 8A provides a non-volatile memory function that stores the power-off signal reception code if the power-off signal has been received. This is the same as the power-off signal reception code storage 8 in the first embodiment. Unlike this, the storage 8A deletes the power-off signal reception code thus stored if the power-off release signal has been received.

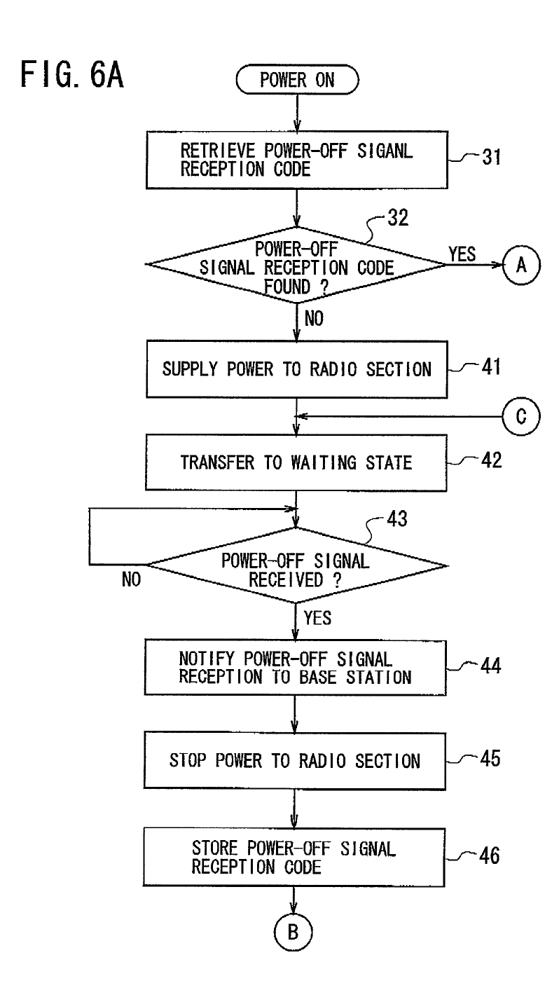

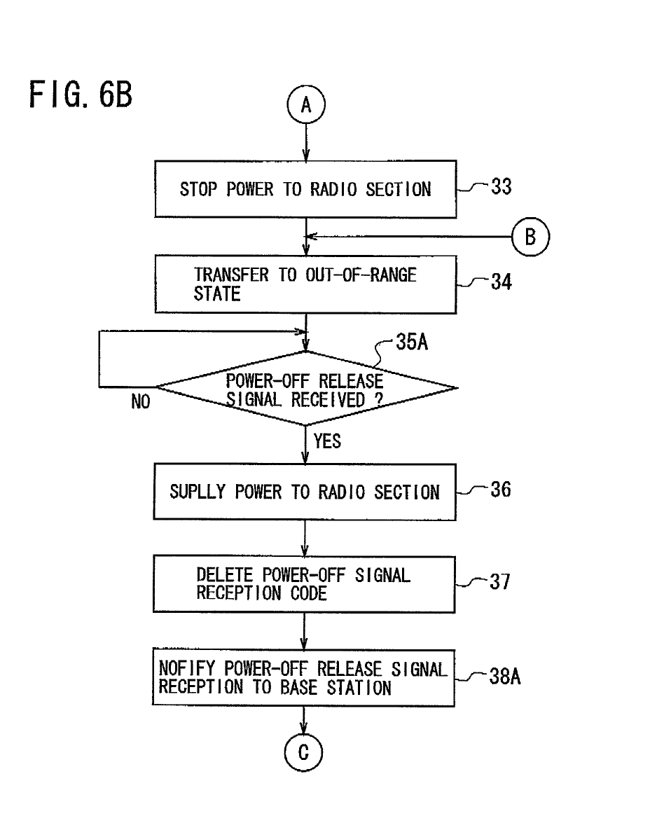

The operation of the telephone 50A of the second embodiment of the invention is shown in FIGS. 6A and 6B. As seen from FIGS. 6A and 6B, the operation of the telephone 50A is the same as that of the telephone 50 of the first embodiment, except that the step 35A and 38A are different from the steps 35 and 38, respectively. Therefore, the explanation about the same steps is omitted here for simplification by attaching the same step numbers as those used in the first embodiment of FIGS. 3a and 3B.

In the step 35A, the controller 10 checks whether the power-off release signal has been received or not by way of the sensor 4. If the power-off release signal has been received by the telephone 50A, in other words, if the power-off signal has not been received, the power supply controller 3 restarts supplying electric power to the radio section 2 in the step 36. Thereafter, the controller 10 deletes the power-off signal reception code from the storage 8 in the step 37, and notifies the power-off release signal reception to the base station 70 in the step 38A. Subsequently, the telephone 50A is transferred to the waiting state in the next step 42. The following flow is the same as the first embodiment.

With the portable radio telephone 50A according to the second embodiment of the invention, it is clear that there are the same advantages as those of the first embodiment because of substantially the same reason as the first embodiment.

### Variations

It is needless to say that the invention is not limited to the above-described first and second embodiments. Any change or modification may be added to the embodiments within the spirit of the invention.

While the preferred forms of the present invention have been described, it is to be understood that modifications will be apparent to those skilled in the art without departing from the spirit of the invention, the scope of the present invention, therefore, is to be determined solely by the following claims.

What is claimed is:

1. A portable radio telephone comprising:
(a) a radio section for receiving an input radio signal and/or transmitting an output radio signal;
(b) a power supply controller for controlling supply of electric power to the radio section responsive to reception of a power-off signal;
the power-off signal being transmitted from a power-off signal transmitter provided in a prohibited area where use of a portable radio telephone is prohibited; and
(c) a power-off signal sensor for sensing reception of the power-off signal to notify the power supply controller of reception of the power-off signal;
wherein when the power-off signal sensor senses reception of the power-off signal, the power supply controller stops supply of electric power to the radio section while keeping additional built-in functions other than communication function operable;
and wherein when the power-oft signal sensor does not sense reception of the power-off signal, the power supply controller continues supply of electric power to the radio section.

2. The telephone according to claim 1, further comprising a connection controller;
wherein the connection controller sends a stop signal to a relating base station to the telephone to stop a connection operation of the base station to the telephone when the power supply controller stops the supply of electric power to the radio section;
and wherein the connection controller sends a stop release signal to the relating base station to the telephone to restart the connection operation of the base station to the telephone when the power supply controller restarts the supply of electric power to the radio section.

3. The telephone according to claim 1, wherein the power-off signal sensor senses the reception of the power-off signal independent of whether the radio section operates or not.

4. The telephone according to claim 2, wherein the power-off signal Sensor senses the reception of the power-off signal independent of whether the radio section operates or not.

5. The telephone according to claim 1, further comprising a non-volatile storage for storing a power-off signal reception code;
wherein when the power-off signal sensor senses reception of the power-off signal, the power-off signal reception code is stored in the storage and kept unchanged even after the telephone is turned off;
and wherein when the telephone is turned on, it is judged whether the power-off signal reception code is stored in the storage or not;
and wherein if the power-off signal reception code is stored in the storage, the power supply controller keeps the supply of electric power to the radio section stopped;
and wherein if the power-off signal reception code is not stored in the storage, the power supply controller restarts the supply of electric power to the radio section.

6. The telephone according to claim 1, wherein when the power-off signal sensor does not sense reception of the power-off release signal, the power-off signal reception code stored in the storage is deleted.

7. The telephone according to claim 1, further comprising a power-off release signal sensor for sensing reception of a power-off release signal to notify the power supply controller of reception of the power-off release signal;
wherein the power-off release signal is transmitted from a power-off release signal transmitter in such a way that the power-off release signal sensor senses the power-off release signal when the telephone is carried out of the prohibited area.

8. The telephone according to claim 1, wherein when the power-off signal is received, a fact that communication function is inoperable is displayed on a screen of a display section.

9. The telephone according to claim 1, wherein the power supply to the radio section can be manually stopped or started by a specific key operation made by the user.

10. The telephone according to claim 1, wherein the power supply to the radio section can be manually stopped or started by a specific key operation made by the user only when the telephone has not received the power-off signal.

11. A method of controlling a portable radio telephone, comprising the steps of:
(a) providing a power-off signal transmitter for transmitting a power-off signal in a prohibited area where use of a portable radio telephone is prohibited;
(b) providing a power-off signal sensor for sensing reception of the power-off signal on a portable radio telephone;
the telephone having a radio section for receiving an input radio signal and/or transmitting an output radio signal;
(c) judging whether the power-off signal sensor senses reception of the power-off signal or not; and
(d) stopping supply of electric power to the radio section of the telephone while keeping additional built-in functions of the telephone other than communication function operable if the power-off signal sensor senses reception of the power-off signal in the step (c);
the supply of electric power to the radio section of the telephone being continued if reception of the power-off signal is not sensed in the step (c).

12. The method according to claim 11, further comprising a step of providing a connection controller on the telephone;
wherein the connection controller sends a stop signal to a relating base station to the telephone to stop a connection operation of the base station to the telephone when the power supply controller stops the supply of electric power to the radio section;
and wherein the connection controller sends a stop release signal to the relating base station to the telephone to restart the connection operation of the base station to the telephone when the power supply controller restarts the supply of electric power to the radio section.

13. The method according to claim 11, wherein the reception of the power-off signal is carried out by the power-off signal sensor independent of whether the radio section operates or not.

14. The method according to claim 12, wherein the reception of the power-off signal is carried out by the power-off signal sensor independent of whether the radio section operates or not.

15. The method according to claim 11, further comprising a step of providing a non-volatile storage for storing a power-off signal reception code on the telephone;
wherein when the power-off signal sensor senses reception of the power-off signal, the power-off signal reception code is stored in the storage and kept unchanged even after the telephone is turned off;
and wherein when the telephone is turned on, it is judged whether the power-off signal reception code is stored in the storage or not;
and wherein if the power-off signal reception code is stored in the storage, the power supply controller keeps the supply of electric power to the radio section stopped;
and wherein if the power-off signal reception code is not stored in the storage, the power supply controller restarts the supply of electric power to the radio section.

16. The method according to claim 11, wherein when the power-off signal sensor does not sense reception of the power-off release signal, the power-off signal reception code stored in the storage is deleted.

17. The method according to claim 11, further comprising a step of providing a power-off release signal sensor for sensing reception of a power-off release signal to notify the power supply controller of reception of the power-off release signal on the telephone;
wherein the power-off release signal is transmitted from a power-off release signal transmitter in such a way that the power-off release signal sensor senses the power-off release signal when the telephone is carried out of the prohibited area.

18. The method according to claim 11, further comprising a step of displaying a fact that communication function is inoperable on a screen of a display section when the power-off signal is received.
